(19) United States
(12) Patent Application Publication
(10) Pub. No.: US 2011/0075031 A1
(43) Pub. Date: Mar. 31, 2011

(54) APPARATUS AND METHOD FOR PROVIDING DIGITAL BROADCASTING IN MOBILE TERMINAL

(75) Inventor: Bu-Seop JUNG, Suwon-si (KR)

(73) Assignee: SAMSUNG ELECTRONICS CO. LTD., Suwon-si (KR)

(21) Appl. No.: 12/893,199

(22) Filed: Sep. 29, 2010

(30) Foreign Application Priority Data
Sep. 29, 2009 (KR) 10-2009-0092172

(51) Int. Cl. H04N 5/45

(52) U.S. Cl. 348/565; 348/E05.112

(57) ABSTRACT

An apparatus and a method for controlling digital broadcasting reproduction such as digital broadcasting reproduction via a sub-screen, reproduction end and channel group management through simple touch drag in a mobile terminal are provided. The apparatus includes a controller. The controller controls a Picture In Picture (PIP) function of the apparatus and controls an operation of channel group management using a drag-and-drop with a main screen output.

### PRIORITY

This application claims the benefit under 35 U.S.C. §119(a) of a Korean patent application filed in the Korean Intellectual Property Office on Sep. 29, 2009 and assigned Ser. No. 10-2009-0092172, the entire disclosure of which is hereby incorporated by reference.

### BACKGROUND OF THE INVENTION

1. Field of the Invention

The present invention relates to an apparatus and a method for processing digital broadcasting in a mobile terminal. More particularly, the present invention relates to an apparatus and a method for controlling digital broadcasting reproduction such as digital broadcasting reproduction via a sub-screen, reproduction end and channel group management through a simple touch drag in a mobile terminal.

2. Description of the Related Art

Recently, as development of mobile terminals increases rapidly, mobile terminals that enable wireless voice communication and information exchange have become a necessity. In the early stages of mobile terminal distribution, a mobile terminal was simply recognized as a product that can be carried and that enables wireless communication. As technology develops and wireless Internet is introduced, the mobile terminal is used not only for simple telephone communication or schedule management but also for games, short distance communication, and image capturing by a mounted digital camera.

Furthermore, as digital broadcasting technology develops, a mobile terminal that supports a reception function of digital broadcast has developed to enable viewing of digital multimedia broadcasting while on the move, drawing much attention from users.

Mobile terminals may also provide a Picture In Picture (PIP) function which uses a portion of a main screen being reproduced as a sub-screen to reproduce a separate screen different from the main screen. The PIP function provides a convenience of viewing another channel simultaneously and an advantage of enabling another channel search without change of a channel that is being reproduced via the current main screen by outputting another sub-screen on the main screen simultaneously.

According to the general PIP function, a user has to output a screen for selecting a menu from a main screen that is currently being output, and then perform the PIP function or select a desired channel. According to this method, however, a portion of a currently viewed screen is covered by the screen for selecting the menu. In addition, where a user of the mobile terminal desires to perform the PIP function, the mobile terminal starts a screen of a predetermined channel and when the predetermined channel is not a channel desired by the user, the mobile terminal has to additionally perform a process of having to select a desired channel.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for improving a digital broadcast service by reducing a digital broadcast control procedure in a mobile terminal.

Another aspect of the present invention is to provide an apparatus and a method for controlling a Picture In Picture (PIP) function using a touch drag in a mobile terminal.

Still another aspect of the present invention is to provide an apparatus and a method for managing a channel group using a touch input in a mobile terminal.

In accordance with an aspect of the present invention, an apparatus for providing digital broadcast in a mobile terminal is provided. The apparatus includes a controller for controlling a PIP function of the mobile terminal and for controlling an operation of channel group management using a drag-and-drop with a main screen output.

In accordance with another aspect of the present invention, a method for providing digital broadcast in a mobile terminal is provided. The method includes controlling a PIP function of the mobile terminal and an operation of channel group management using a drag-and-drop with a main screen output.

In accordance with another aspect of the present invention, an apparatus for controlling a PIP function in a mobile terminal is provided. The apparatus includes a touch manager unit for detecting a user's touch input, a function determining unit for determining a touch input detected by the touch manager unit to determine a PIP function control input, and a controller for controlling a PIP function based on the PIP function control input by the function determining unit.

In accordance with another aspect of the present invention, a mobile terminal is provided. The mobile terminal includes a display unit for displaying a user interface including a channel list having a plurality of icons corresponding to channels and a main region divided into a plurality of sub-regions, an input unit for receiving input from a user, and a controller for determining whether a user has dragged an icon corresponding to a channel from the channel list to a first sub-region, and when the user has dragged the icon, for entering into a PIP mode and displaying content corresponding to the channel in the first sub-region.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile terminal for providing digital broadcast according to an exemplary embodiment of the present invention;

FIG. 2 is a flowchart illustrating a process where a user of a mobile terminal controls digital broadcast according to an exemplary embodiment of the present invention;

FIG. 3 is a flowchart illustrating a process for controlling digital broadcast in a mobile terminal according to an exemplary embodiment of the present invention;

FIG. 4A is a view illustrating screens turning on/off a Picture In Picture (PIP) function in a mobile terminal according to an exemplary embodiment of the present invention;

FIG. 4B is a view illustrating a channel search screen through a PIP function in a mobile terminal according to an exemplary embodiment of the present invention; and

FIG. 4C is a view illustrating screens managing a channel group in a mobile terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for improving a digital broadcast service by reducing a procedure for controlling a Picture In Picture (PIP) function using a touch drag in a mobile terminal.

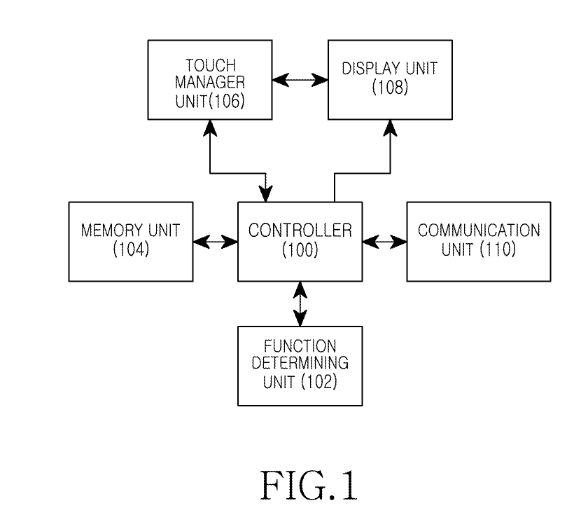

FIG. 1 is a block diagram illustrating a mobile terminal for providing digital broadcast according to an exemplary embodiment of the present invention.

Referring to FIG. 1, the mobile terminal may include a controller 100, a function determining unit 102, a memory unit 104, a touch manager unit 106, a display unit 108, and a communication unit 110. The portable terminal may include additional units. Similarly, the functionality of two or more of the above units may be integrated into a single component.

The controller 100 of the mobile terminal controls an overall operation of the mobile terminal. For example, the controller 100 performs processes and controls for voice communication and data communication. In addition to the general operations, according to an exemplary embodiment of the present invention, the controller 100 controls a Picture In Picture (PIP) function in response to a user's touch input. The controller 100 controls the PIP function without a separate menu selection to simplify the conventional PIP function control process by performing and controlling the PIP function or managing channel information according to a touch input detected from the user of the mobile terminal.

For example, when detecting a channel button drag from the user, the controller 100 activates the PIP function by outputting a channel corresponding to the detected channel button via a sub-screen. Additionally, when detecting the user's input of touching and dragging the sub-screen, the controller 100 ends the PIP function to end broadcast output via the sub-screen.

The function determining unit 102 determines a PIP function control input desired by the user of the mobile terminal under control of the controller 100. The function determining unit 102 determines whether the user of the mobile terminal performs or ends the PIP function or manages channel information using the user's touch input information provided by the touch manager unit 106 to provide the same to the controller 100.

The memory unit 104 includes, for example, Read Only Memory (ROM), Random Access Memory (RAM), a flash ROM, and the like. The ROM stores microcode (i.e., code) of programs for processes and controls of the controller 100 and the function determining unit 102, and various reference data. The RAM serves as a working memory of the controller 100 and stores temporary data that occur during execution of various programs. The flash ROM stores various updatable data for storage, such as a phonebook, calling messages, and received messages.

The touch manager unit 106 detects the user's touch input to perform an operation corresponding to the touch input under control of the controller 100. When the user's touch input occurs, the touch manager unit 106 provides a position of a relevant point where the touch input has occurred to the controller 100 or the function determining unit 102, or the touch manager unit 106 determines data corresponding to the position of the relevant point to output the relevant data to the display unit 108.

The display unit 108 displays status information generated during an operation of the mobile terminal, letters, moving images and still images, and the like. The display unit 108 may be a color Liquid Crystal Display (LCD), an Active Mode Organic Light Emitting Diode (AMOLED), and the like. The display unit 108 may include a touch input device, and when the display unit 108 is applied to a touch input type mobile terminal, the display unit 108 can be used as an input unit.

The communication unit 110 transmits/receives a Radio Frequency (RF) signal of data input/output via an antenna (not illustrated). For example, during transmission, the communication unit 110 channel-codes and spreads data to be transmitted, and then performs an RF process on the signal to transmit the signal. During reception, the communication unit 110 converts a received RF signal into a baseband signal, and despreads and channel-decodes the baseband signal to recover data.

The operations of the function determining unit 102 may be performed by the controller 100 of the mobile terminal. Separate configuration and illustration of the function determining unit 102 are for exemplary purposes only and for convenience in description, and is not limiting to the scope of the present invention. It would be obvious to those skilled in the art that various modifications may be made within the scope of the present invention. For example, all functions of the function determining unit 102 may be processed by the controller 100.

An exemplary apparatus for improving a digital broadcast service by reducing a procedure of controlling the PIP function using a touch drag in a mobile terminal has been described above. An exemplary method for controlling the PIP function without a process of selecting a separate menu through a simple touch input according to an exemplary embodiment of the present invention is described below.

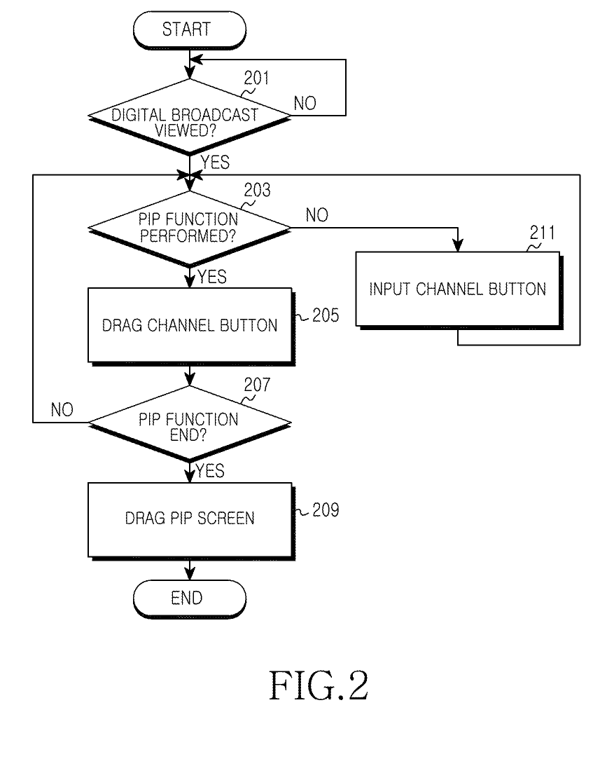

FIG. 2 is a flowchart illustrating a process where a user of a mobile terminal controls digital broadcast according to an exemplary embodiment of the present invention.

Referring to FIG. 2, the user of the mobile terminal determines whether a digital broadcast view event occurs in step 201. If it is determined in step 201 that the digital broadcast view event does not occur, the user of the mobile terminal re-performs the process of step 201. If it is determined in step 201 that the digital broadcast view event occurs, the user of the mobile terminal determines whether to perform a Picture In Picture (PIP) function or perform a channel change in step 203.

The PIP function may be requested by dragging a channel button output on an output screen of the mobile terminal. When touching and inputting the channel button, the user of the mobile terminal performs a channel change to the relevant channel. When dragging the channel button to a specific position with the channel button touched, the user of the mobile terminal performs the PIP function of outputting a screen of the relevant channel via a sub-screen.

If it is determined in step 203 that a channel change is being performed without performing the PIP function, the user of the mobile terminal inputs a channel button to perform a channel change in step 211, and re-performs the process of step 203. If it is determined in step 203 that the PIP function is being performed, the user of the mobile terminal drags a channel button to a sub-screen in step 205. The mobile terminal reproduces a channel corresponding to the channel button dragged by the user via the sub-screen to start the PIP function with the channel desired by the user, so that a problem that the conventional mobile terminal starts with a channel set as a default when performing the PIP function may be resolved.

The user of the mobile terminal, who has performed the PIP function as described above, determines whether to end the PIP function in step 207. If it is determined in step 207 that the user has determined not to end the PIP function, the user of the mobile terminal re-performs the process of step 203. If it is determined in step 207 that the user has determined to end the PIP function, the user of the mobile terminal drags the PIP-processed screen, that is, broadcast output via the sub-screen to a place where the channel button is positioned to end the PIP function in step 209.

According to an exemplary embodiment of the present invention, a button corresponding to a desired channel is dragged to the PIP screen, so that the PIP function is performed. To end the PIP function, broadcast output via the PIP screen is touched and dragged to a predetermined position.

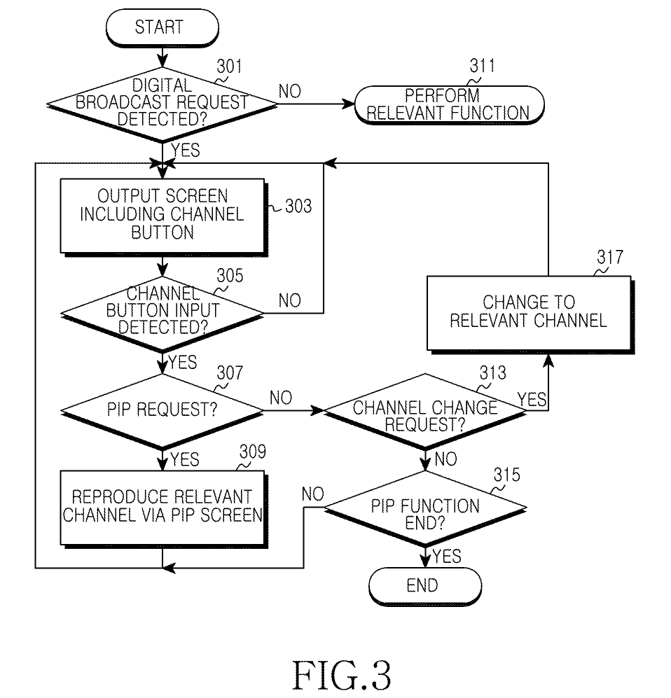

FIG. 3 is a flowchart illustrating a process for controlling digital broadcast in a mobile terminal according to an exemplary embodiment of the present invention.

Referring to FIG. 3, the mobile terminal determines whether a digital broadcast view request is detected in step 301. If it is determined in step 301 that the digital broadcast view request is not detected, the mobile terminal performs a relevant function (e.g., a standby mode) in step 311.

If it is determined in step 301 that the digital broadcast view request is detected, the mobile terminal outputs a screen including a channel button in step 303. The channel button is a button for selecting each channel. The user may touch a relevant button to view a channel corresponding to the relevant button. In addition, when detecting a separate input by the user after outputting a channel corresponding to the user's request, the mobile terminal outputs a channel button on a predetermined region of the main screen or outputs the channel button and the main screen simultaneously as in step 303.

The mobile terminal determines whether an input of the channel button that is being output is detected in step 305. The input of the channel button includes an input for selecting a channel corresponding to a relevant button and an input for dragging the channel button to reproduce broadcast of the relevant channel via a sub-screen.

If it is determined in step 305 that the input of the channel button is not detected, the mobile terminal re-performs the process of step 303 to output a channel that is currently viewed. If it is determined in step 305 that the input of the channel button is detected, the mobile terminal determines whether the input of the channel button detected in step 305 is a Picture In Picture (PIP) function request for dragging the channel button to reproduce broadcast of the relevant channel via the sub-screen in step 307.

If it is determined in step 307 that the input of the channel button is the PIP function request, the mobile terminal reproduces a channel corresponding to the channel button that has detected the user's input via the sub-screen in step 309, and re-performs the process of step 305. If it is determined in step 307 that the input of the channel button is not the PIP function request, the mobile terminal determines whether the input of the channel button is a channel change request for selecting a channel corresponding to a relevant button in step 313.

If it is determined in step 313 that the input of the channel button is the channel change request, the mobile terminal changes the channel that is currently output into a channel corresponding to the channel button input by the user in step 317. If it is determined in step 313 that the input of the channel button is not the channel change request, the mobile terminal determines whether an input for requesting a PIP function end is detected in step 315. The input for requesting the PIP function end may be performed by touching the sub-screen output by execution of the PIP function, and then dragging the sub-screen to a specific region.

If it is determined in step 315 that the input for requesting the end of the PIP function is not detected, the mobile terminal re-performs the process of step 305. If it is determined in step 315 that the input for requesting the end of the PIP function is detected, for example, when the user touches a screen on the sub-screen and drags the screen to a predetermined position (PIP end button), the mobile terminal ends the process.

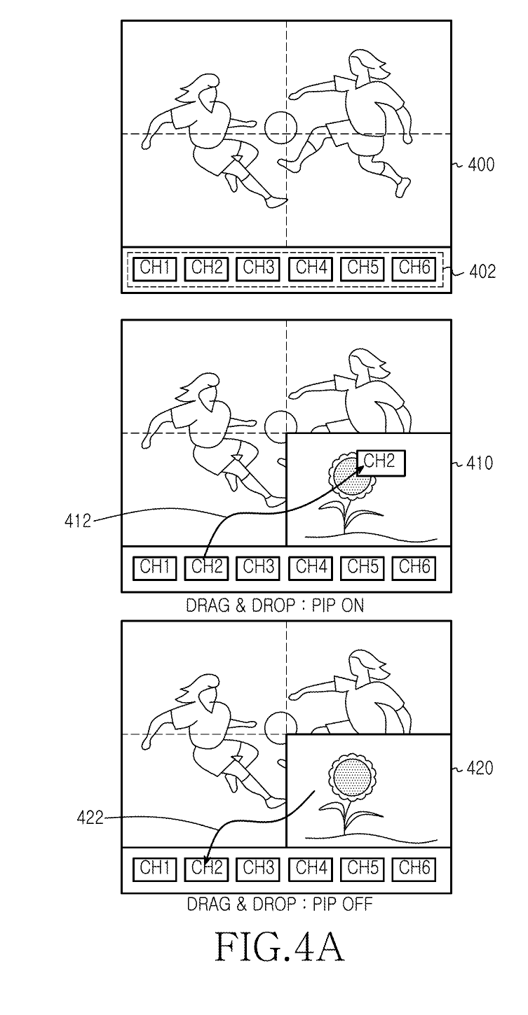

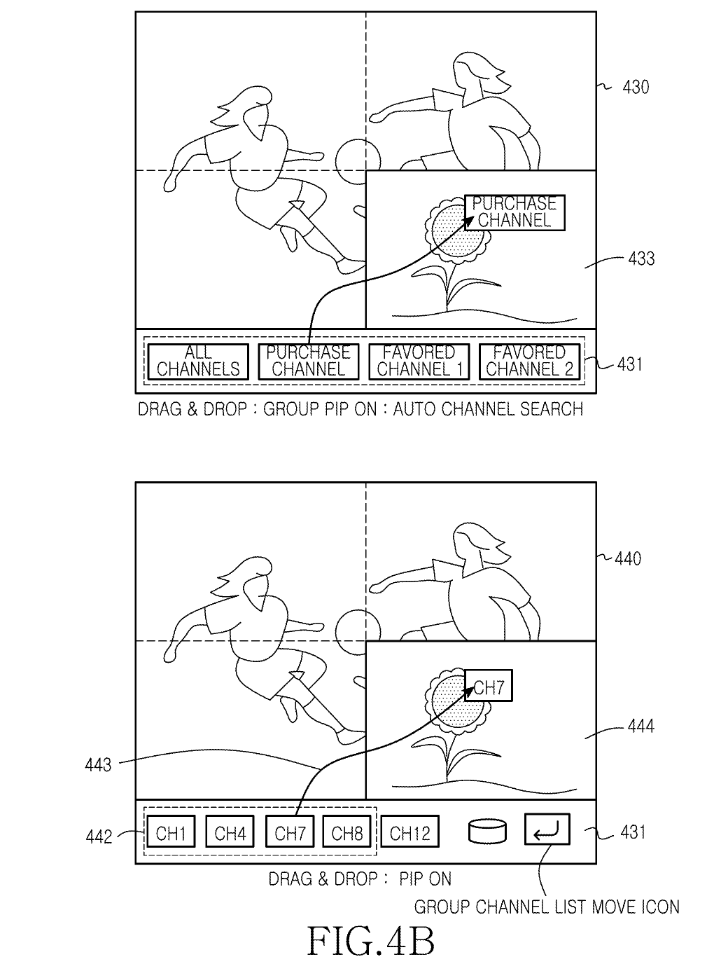

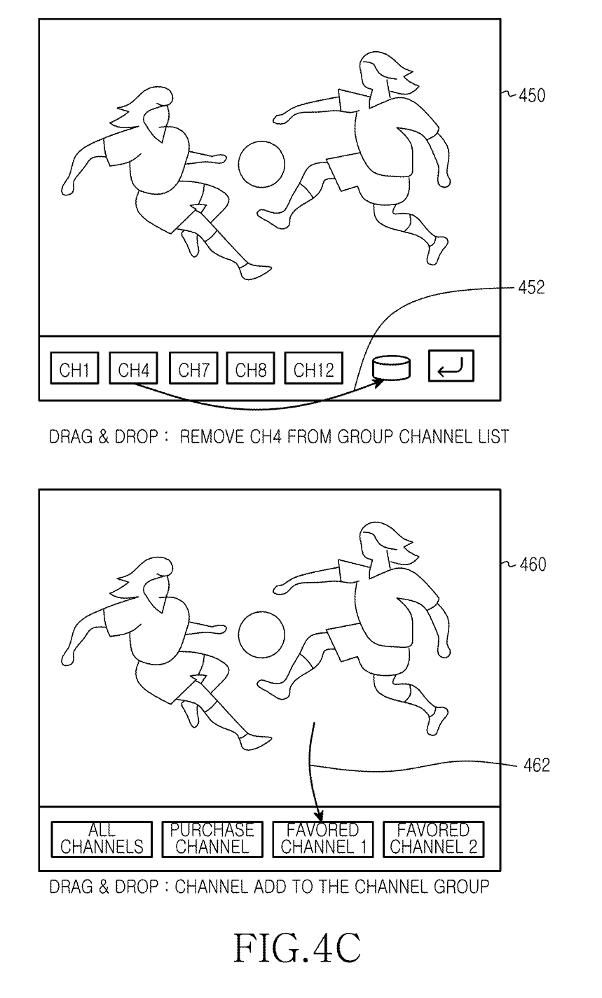

FIGS. 4A-4C are views illustrating screens controlling digital broadcast in a mobile terminal according to an exemplary embodiment of the present invention.

FIG. 4A is a view illustrating screens turning on/off a Picture In Picture (PIP) function in a mobile terminal according to an exemplary embodiment of the present invention.

Referring to FIG. 4A, when providing digital broadcast, the mobile terminal outputs channel buttons 402 for selecting a channel together as in screen 400. The mobile terminal may output the channel buttons together with a main screen simultaneously while outputting digital broadcast, or may output the channel buttons on the main screen when a touch input by a user occurs while outputting the digital broadcast.

When performing the PIP function using the mobile terminal in this state, the user of the mobile terminal drags (412) a channel button corresponding to a channel the user desires to reproduce via a PIP screen to the screen 410 that currently outputs digital broadcast according to an exemplary embodiment of the present invention.

This omits a process for selecting (touching the main screen to output a menu for changing a channel, and then selecting a relevant channel) a separate menu in the conventional mobile terminal, and allows the user to reproduce broadcast of a desired channel via the PIP screen. In addition, as illustrated in FIG. 4A, the mobile terminal according to an exemplary embodiment of the present invention may divide the position of the sub-screen by dividing the output screen into four equal regions (region 1 to region 4). Accordingly, the user of the mobile terminal drags the channel button to a desired position to perform the PIP function at the relevant position and change the position of the sub-screen.

As described above, when intending to end the PIP function while performing the PIP function, the user of the mobile terminal touches a screen 420 that is being reproduced via the sub-screen and drags (422) the screen to the position at which the channel button is positioned, thereby ending the PIP function and reproducing only the main screen.

FIG. 4B is a view illustrating a channel search screen through a Picture In Picture (PIP) function in a mobile terminal according to an exemplary embodiment of the present invention.

Referring to FIG. 4B, when determining that a touch occurs on a main screen 430 on which digital broadcast is output during channel search via the PIP function, the mobile terminal may output a channel button. According to an exemplary embodiment of the present invention, the mobile terminal may output first a list 431 of a user-defined channel group such as all channels, a purchase channel, and favored channels 1 and 2.

Accordingly, a user of the mobile terminal drags the channel group list to a sub-screen position 433 for the PIP function to search only channels registered in a relevant channel group list. For example, when detecting an input for searching for a channel from a user, the mobile terminal outputs the channel group list such as all channels, a purchase channel, and favored channels 1 and 2 via the main screen, and then detects selection of a channel group for the user's search.

When the user of the mobile terminal performs a channel search on a purchase channel group, the mobile terminal outputs channel information 442 included in the purchase channel group via the main screen 440. Accordingly, the user of the mobile terminal performs (443) the PIP function by selecting a channel included in the purchase channel group and dragging the channel to a sub-screen 444. When outputting channel information included in the purchase channel group and then intending to determine a previous group channel list, the user selects an icon for returning to the purchase channel list to enter a previous step.

Additionally, according to an exemplary embodiment of the present invention, the mobile terminal may sequentially change broadcast of channels included in a relevant channel group by a predetermined time interval to provide information of channels registered in a relevant channel group to a user.

FIG. 4C is a view illustrating screens managing a channel group in a mobile terminal according to an exemplary embodiment of the present invention.

Referring to FIG. 4C, when outputting digital broadcast via a main screen or a sub-screen in order to manage channel groups included in a channel group list, the mobile terminal may output the channel group list via the screen. The channel group management may be performed even when the channel group list for channel search is output. When a channel group included in the channel group list is selected as described above, channel information included in the channel group is output as described above.

The user of the mobile terminal may select a relevant channel to perform a channel search process. In the case where the user desires to delete a channel included in a relevant channel group, the user drags a channel button corresponding to the channel to be deleted from channel information included in the channel group to an icon delete region such as a trash bin. For example, as illustrated in FIG. 4C, when the user of the mobile terminal desires to delete a channel 4 while viewing digital broadcast via a main screen 450, the mobile terminal touches the channel 4 and drags (452) the channel 4 to a trash bin icon, thereby deleting channel information of the relevant channel group (channel 4 in this case).

Additionally, the mobile terminal drags a channel of digital broadcast that is reproduced via the main screen or the sub-screen to a channel group to add channel information to a relevant channel group. For example, when the user of the mobile terminal desires to add a channel of digital broadcast 460 that is currently output as a favored channel 1, the user of the mobile terminal touches the channel that is currently output via the main screen and drags (462) the channel to a channel group corresponding to the favored channel 1, thereby changing channel information of the favored channel 1.

As described above, exemplary embodiments of the present invention provide an apparatus and a method for improving a digital broadcast service by reducing a procedure of controlling the PIP function using a touch drag in a mobile terminal. The method may control the PIP function without a process of selecting a separate menu which has been performed in the conventional mobile terminal by ending execution of the PIP function using a simple touch input.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing digital broadcast in a mobile terminal, the apparatus comprising:
a controller for controlling a Picture In Picture (PIP) function of the mobile terminal and for controlling an operation of channel group management using a drag-and-drop with a main screen output.

2. The apparatus of claim 1, wherein after outputting a channel button for channel change to the main screen, when the controller determines that the channel button is dragged to a position of a sub-screen, the controller outputs the PIP function to output the sub-screen.

3. The apparatus of claim 2, wherein the sub-screen comprises a screen for outputting a digital broadcast of a channel corresponding to the dragged channel button.

4. The apparatus of claim 3, wherein the sub-screen uses one of a plurality of regions into which the main screen is divided, and changes a position of the sub-screen according to a user's selection.

5. The apparatus of claim 1, wherein the controller controls the PIP function by ending the PIP function when a sub-screen that is being output by execution of the PIP function is dragged.

6. The apparatus of claim 1, wherein the controller controls the operation of the channel group management by adding or deleting a channel forming a channel group when the main screen that is being output is dragged.

7. A method for providing digital broadcast in a mobile terminal, the method comprising:
controlling a Picture In Picture (PIP) function of the mobile terminal and an operation of channel group management using a drag-and-drop with a main screen output.

8. The method of claim 7, wherein the controlling of the PIP function using the drag-and-drop comprises:
outputting a channel button for channel change via the main screen;
dragging the channel button to a position of a sub-screen; and
executing the PIP function to output a sub-screen.

9. The method of claim 8, wherein the sub-screen comprises a screen for outputting a digital broadcast of a channel corresponding to the dragged channel button.

10. The method of claim 9, wherein the sub-screen uses one of a plurality of regions into which the main screen is divided, and changes a position of the sub-screen according to a user's selection.

11. The method of claim 7, wherein the controlling of the PIP function using the drag-and-drop comprises executing the PIP function and dragging a sub-screen that is being output to end the PIP function.

12. The method of claim 7, wherein the controlling of the operation of the channel group management comprises dragging the main screen that is being output to add or delete a channel forming a channel group.

13. An apparatus for controlling a Picture In Picture (PIP) function in a mobile terminal, the apparatus comprising:
a display unit for displaying a user interface including a channel list having a plurality of icons corresponding to channels and a main region divided into a plurality of sub-regions;
a touch manager unit for detecting a user's touch input;
a function determining unit for determining a touch input detected by the touch manager unit to determine a PIP function control input; and
a controller for controlling a PIP function based on the PIP function control input by the function determining unit.

14. The apparatus of claim 13, wherein when determining that a channel button is dragged to a position of a sub-screen, the function determining unit determines the PIP function control input that allows the PIP function to be executed.

15. The apparatus of claim 13, wherein the function determining unit determines the PIP function control input that divides a main screen into a plurality of regions and uses one of the divided regions for PIP.

16. The apparatus of claim 13, wherein when detecting that a sub-screen is dragged, the function determining unit determines the PIP function control input that ends the PIP function.

17. The apparatus of claim 13, wherein when detecting that a main screen that is being output is dragged, the function determining unit determines the PIP function control input that adds or deletes a channel forming a channel group.

18. The mobile terminal of claim 13, wherein, when the controller determines that a user has dragged an icon corresponding to a channel from the channel list to a first sub-region, the controller enters into a Picture-In-Picture (PIP) mode and displaying content corresponding to the channel in the first sub-region.

19. The mobile terminal of claim 18, wherein, when the controller determines that the user has dragged content displayed in a second sub-region to the channel list, the controller exits the PIP mode and stops displaying the content in the sub-region.
